(19) United States
(12) Patent Application Publication
(10) Pub. No.: US 2013/0275769 A1
(43) Pub. Date: Oct. 17, 2013

(54) METHOD, DEVICE, AND SYSTEM FOR PROTECTING AND SECURELY DELIVERING MEDIA CONTENT

(71) Applicants: Hormuzd M. Khosravi, Portland, OR (US); Sudheer Mogilappagari, Hillsboro, OR (US); Priyalee Kushwaha, Hillsboro, OR (US); Sunil A. Cheruvu, Chandler, AZ (US); David A. Schollmeyer, Chandler, AZ (US)

(72) Inventors: Hormuzd M. Khosravi, Portland, OR (US); Sudheer Mogilappagari, Hillsboro, OR (US); Priyalee Kushwaha, Hillsboro, OR (US); Sunil A. Cheruvu, Chandler, AZ (US); David A. Schollmeyer, Chandler, AZ (US)

(21) Appl. No.: 13/976,042

(22) PCT Filed: Dec. 15, 2011
(86) PCT No.: PCT/US11/65072

§ 371 Date: Jun. 26, 2013

(51) Int. Cl. G06F 21/60

(52) U.S. Cl. CPC G06F 21/602
USPC 713/189

(57) ABSTRACT

A method, device, and system for protecting and securely delivering media content includes configuring a memory controller of a system-on-a-chip (SOC) to establish a protected memory region, authenticating a firmware of a hardware peripheral using a security engine of the SOC, and storing the authenticated firmware in the protected memory region. The security engine may authenticate the firmware by authenticating a peripheral cryptographic key used to encrypt the firmware. Only authenticated hardware peripherals may access the protected memory region.

### BACKGROUND

The way in which content users access media content is changing from the traditional opportunistic access to on-demand access. On-demand media content, as well as some standard media content, is often delivered by streaming the content to a multimedia platform, such as a set-top box, a smart phone, a computer tables, a laptop, or the like. If the multimedia content is premium content, the multimedia content is often protected in some manner during transmission to the multimedia platform. For example, various Digital Rights Management (DRM) and Conditional Access (CA) technologies may be used to provide protection for the media content from the media source to the multimedia platform. Such technologies generally involve encryption of the content media.

System-on-a-chip (SOC) devices are integrated circuits that incorporate various components, in addition to the processing core, of electronic systems on a single die. For example, an SOC may include a processor core, memory controller, video components, audio components, and/or communication components on a single chip. Due to their relatively small size, SOCs are used in many multimedia platforms.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale, For example, the dimensions of some elements may be exaggerated relative to other elements for clarity. Further, where considered appropriate, reference labels have been repeated among the figures to indicate corresponding or analogous elements.

FIG. 1 is a simplified block diagram of at least one embodiment of a multimedia platform including a system-on-a-chip (SOC);

FIG. 2 is a simplified block diagram of at least one embodiment of a memory controller and memory of the multimedia platform of FIG. 1;

FIG. 3 is a simplified block diagram of at least one embodiment of a protected media content flow of the SOC of FIG. 1;

FIG. 4 is a simplified flow diagram of at least one embodiment of a method for establishing a protected memory region in the SOC of FIG. 1;

FIG. 5 is a simplified flow diagram of at least one embodiment of a method for authenticating a hardware peripheral of the SOC of FIG. 1; and

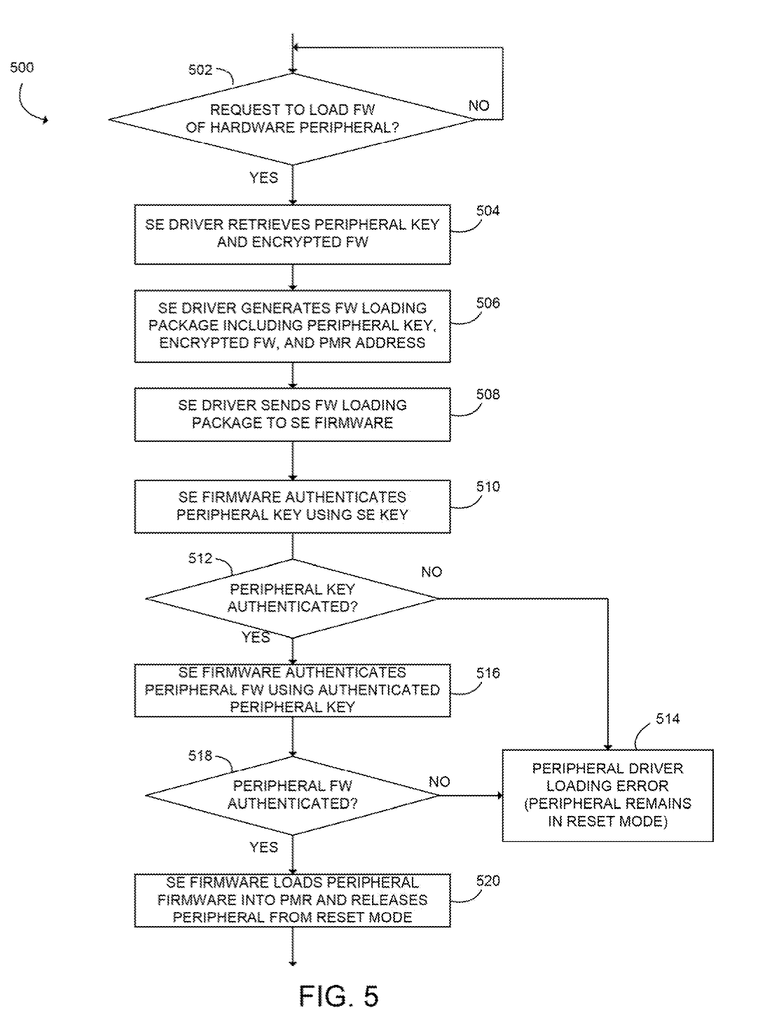

FIG. 6 is a simplified flow diagram of at least one embodiment of a method for delivering content media from the SOC of FIG. 1;

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present disclosure. It will be appreciated, however, by one skilled in the art that embodiments of the disclosure may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention implemented in a computer system may include one or more bus-based interconnects or links between components and/or one or more point-to-point interconnects between components. Embodiments of the invention may also be implemented as instructions carried by or stored on a transitory or non-transitory machine-readable medium, which may be read and executed by one or more processors. A machine-readable medium may be embodied as any device, mechanism, or physical structure for storing or transmitting information in a form readable by a machine (e.g., a computing device). For example, a machine-readable medium may be embodied as read only memory (ROM); random access memory (RAM); magnetic disk storage media; optical storage media; flash memory devices; mini- or micro-SD cards, memory sticks, electrical signals, and others.

In the drawings, specific arrangements or orderings of schematic elements, such as those representing devices, modules, instruction blocks and data elements, may be shown for ease of description. However, it should be understood by those skilled in the art that the specific ordering or arrangement of the schematic elements in the drawings is not meant to imply that a particular order or sequence of processing, or separation of processes, is required. Further, the inclusion of a schematic element in a drawing is not meant to imply that such element is required in all embodiments or that the features represented by such element may not be included in or combined with other elements in some embodiments.

In general, schematic elements used to represent instruction blocks may he implemented using any suitable form of machine-readable instruction, such as software or firmware applications, programs, functions, modules, routines, processes, procedures, plug-ins, applets, widgets, code fragments and/or others, and that each such instruction may he implemented using any suitable programming language, library, application programming interface (API), and/or other software development tools. For example, some embodiments may he implemented using Java, C++, and/or other programming languages. Similarly, schematic elements used to represent data or information may be implemented using any suitable electronic arrangement or structure, such as a register, data store, table, record, array, index, hash, map, tree, list, graph, file (of any file type), folder, directory, database, and/or others.

Further, in the drawings, where connecting elements, such as solid or dashed lines or arrows, are used to illustrate a connection, relationship or association between or among two or more other schematic elements, the absence of any such connecting elements is not meant to imply that no connection, relationship or association can exist. In other words, some connections, relationships or associations between elements may not be shown in the drawings so as not to obscure the disclosure. In addition, for ease of illustration, a single connecting element may be used to represent multiple connections, relationships or associations between elements. For example, where a connecting element represents a communication of signals, data or instructions, it should be understood by those skilled in the art that such element may represent one or multiple signal paths (e.g., a bus), as may be needed, to effect the communication.

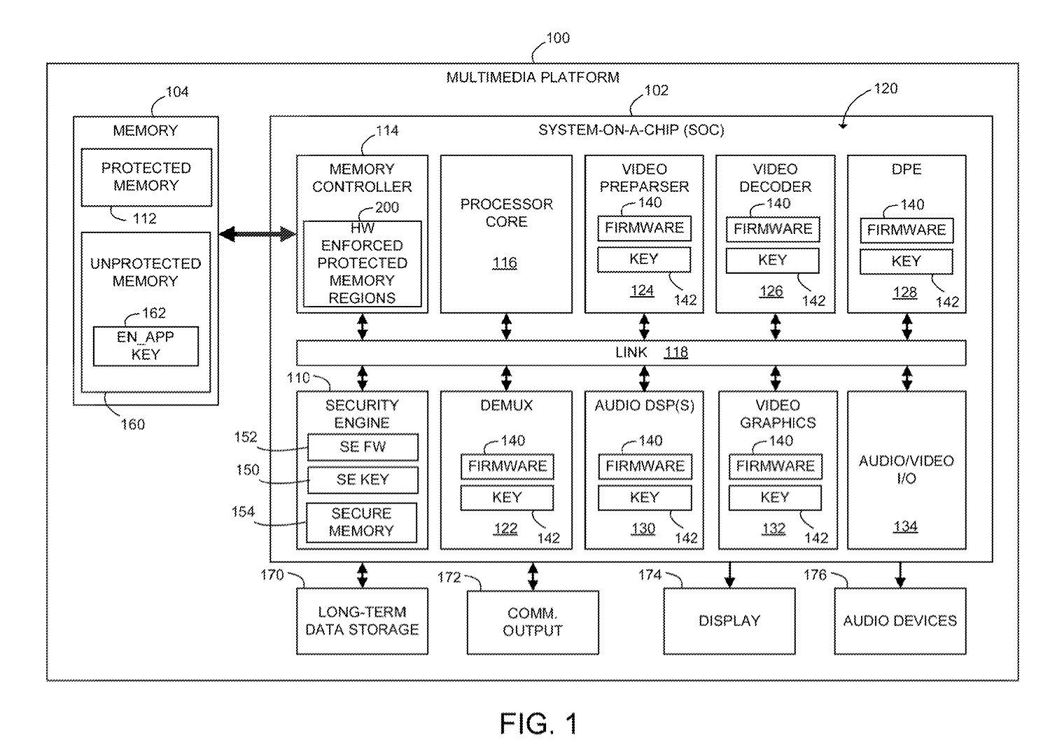

Referring now to FIG. 1, in one embodiment, a multimedia platform 100 is configured to deliver media content to a user of the platform 100. The multimedia platform 100 may be embodied as any type of device configured to deliver media content. For example, the multimedia platform may be embodied as a set-top box, a smartphone, a tablet computer, a laptop computer, a mobile interact device (MID), a desktop computer, or other device capable of delivery of media content. The multimedia platform 100 may be configured to deliver any type of media content to the user including, for example, movies, pictures, images, songs, audio and/or video recordings, and/or any other type of audio, video, and/or audio and video content.

The multimedia platform 100 includes a system-on-a-chip (SOC) 102 and a platform memory 104. As discussed in more detail below, the SOC 102 is configured to protect and securely deliver the media content while within the SOC 102 and memory 104. To do so, a security engine 110 of the SOC 102 establishes a protected memory 112 in the memory 104, which is hardware enforced by a memory controller 114 of the SOC 102. The memory controller 114 ensures that only authorized hardware peripherals of the SOC 102 may access the protected memory 112. The security engine 110 of the SOC 102 authorizes each hardware peripheral by authenticating the firmware of each peripheral prior to loading the firmware in the protected memory 112. Decrypted media content is also stored in the protected memory 112 and is accessible only by authorized hardware peripherals. In this way, a trusted data path is established in the SOC 102 wherein decrypted media content is accessible only by authenticated components of the SOC 102.

The SOC 102 may he embodied as any type of system-on-a-chip, which may include various components and structures. In the illustrative embodiment of FIG. 1, the SOC 102 includes the security engine 110 and memory controller 114 as discussed above, a processor core 116, and a plurality of hardware peripherals 120, which are communicatively coupled to each other via a link 118. The link 118 may be embodied as any type of interconnect such as a bus, point-to-point, or other interconnect capable of facilitating communication between the various components of the SOC 102. The hardware peripherals 120 may include any type of hardware peripheral component depending upon the intended functionality of the SOC 102, For example, in the illustrative embodiment, the hardware peripherals 120 include a demux 122, a video preparser 124, a video decoder 126, a Display Processing Engine (DPE) 128, an audio digital signal processor (DSP) 130, a video graphics 132, and an audio/video I/O 134. Each of the hardware peripherals 120 includes an associated firmware 140 and a cryptographic key 142, As discussed in more detail below, the cryptographic key 142 of each hardware peripheral 120 is previously signed by the security engine 110 using a security key 150 of the security engine 110.

The security engine 110 may be embodied as a security co-processor or processing circuitry separate from the processor core 116. The security engine 110 includes a security engine firmware 152 and a secure memory 154, which is accessible only by the security engine 110. In the illustrative embodiment, the secure memory 154 forms a physical portion of the security engine 110, but may form a portion of the memory 104 in other embodiments (i.e., a portion of the protected memory 112). The security engine 110 stores the security key 150, and other cryptographic keys as discussed below, in the secure memory 154. The security key 150 may be provisioned during the manufacturing of the SOC 102 or may be generated by the SOC 102 during operation. For example, in some embodiments, the security key 150 is based on blown fuses within the security engine 110. Additionally or alternatively, the security engine 110 may include a key-generating module, such as a trusted platform module (TPM), to generate the security key 150. During use, the security engine 110 may use any number of security keys 150, which may be identical or different from each other.

As discussed above, the memory 104 includes the protected memory 112 and an unprotected memory 160. Various data may be stored in the unprotected memory 160 in a decrypted or encrypted form during operation of the multimedia platform 100. For example, as discussed in more detail below, an encrypted application key 162 may be stored in the unprotected memory 160 of the memory 104, along with any encrypted media content for delivery to a user.

In some embodiments, the multimedia platform 100 may include additional components and structures other than the SOC 102 and memory 104. For example, in the illustrative embodiment, the multimedia platform 100 includes a long-term data storage 170 such as a hard drive or solid-state drive, a communications output 172, a display 174, and audio devices 176 such as speakers, each of which may be communicate or otherwise interact with the SOC 102.

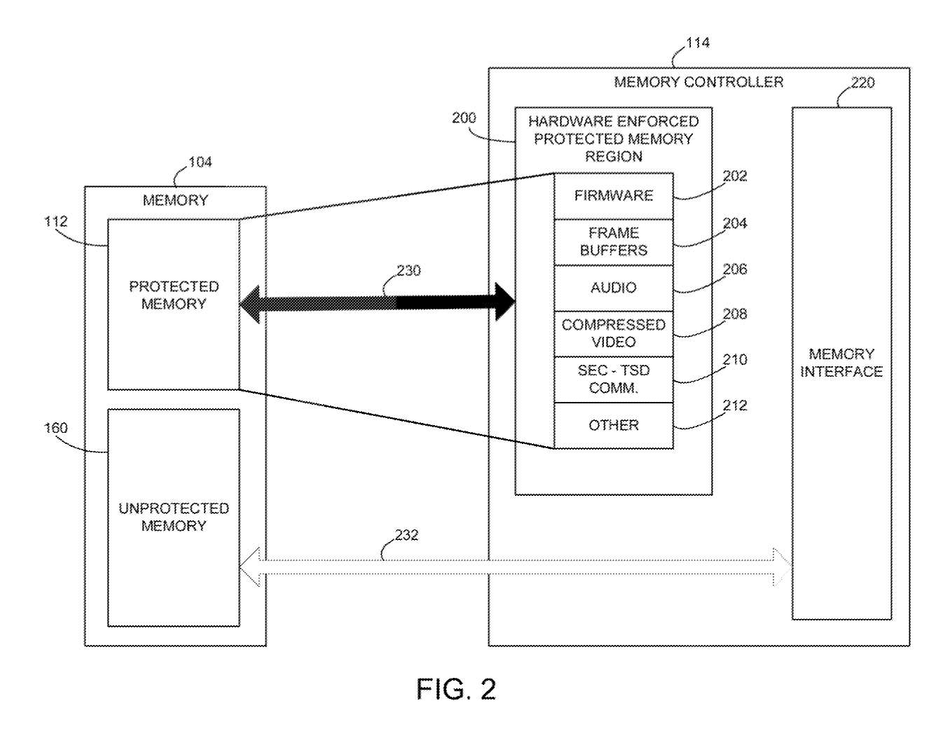

Referring now to FIG. 2, as discussed above, the protected memory 112 of the memory 104 is enforced by the memory controller 114. To do so, the memory controller 114 is configured to establish a hardware enforced protected memory region 200, which correlates and defines the protected memory 112 of the memory 102. The hardware enforced protected memory region may include any number of protected memory regions or sub-regions. For example, in the illustrative embodiment of FIG. 2, the hardware enforced protected memory region includes a firmware protected memory region 202 in which authenticated firmware is stored, a frame buffer protected memory region 204 in which decrypted video is stored, an audio protected memory region 206 in which decrypted audio is stored, a compressed video protected memory region 208, a security engine-to-Transport Stream Demultiplexor (TSD) protected memory region 210, and/or one or more other protected memory regions 212, Of course, in other embodiments, the hardware enforced protected memory region 200 may include fewer or greater number protected memory regions depending on, for example, the intended functionality of the SOC 102.

Each of the protected memory regions 202, 204, 206, 208, 210, 212 may include similar or different security attributes depending on the respective use. The memory controller 114 secures such attributes into corresponding registers such that the attributes cannot be subsequently altered. Additionally, the memory controller 114 may ensure that the protected memory regions 202, 204, 206, 208, 210, 212 are configured appropriately (e.g., that the corresponding memory addresses do not overlap) and, in some embodiments, may perform other security and error checks on the protected memory 112.

During use, the memory controller 114 provides hardware enforced protection for the protected memory 112. For example, a hardware peripheral 120 may communicate with a memory interface 220 of the memory controller 114 to retrieve data from the memory 102. The memory controller 114 determines whether the hardware peripheral 120 is requesting data from the protected memory 112 (e.g., from one of the protected memory regions 200). If so, the memory controller 114 allows access (arrow 230) to the corresponding hardware enforced protected memory region 200 of the protected memory 112 only if the requesting hardware peripheral 120 has been previously authenticated by the security engine 110 as discussed below. If not, the memory controller 114 denies the requested access. Alternatively, the hardware peripheral 120 may request access (arrow 232) to the unprotected memory 160, which is allowed by the memory controller 114.

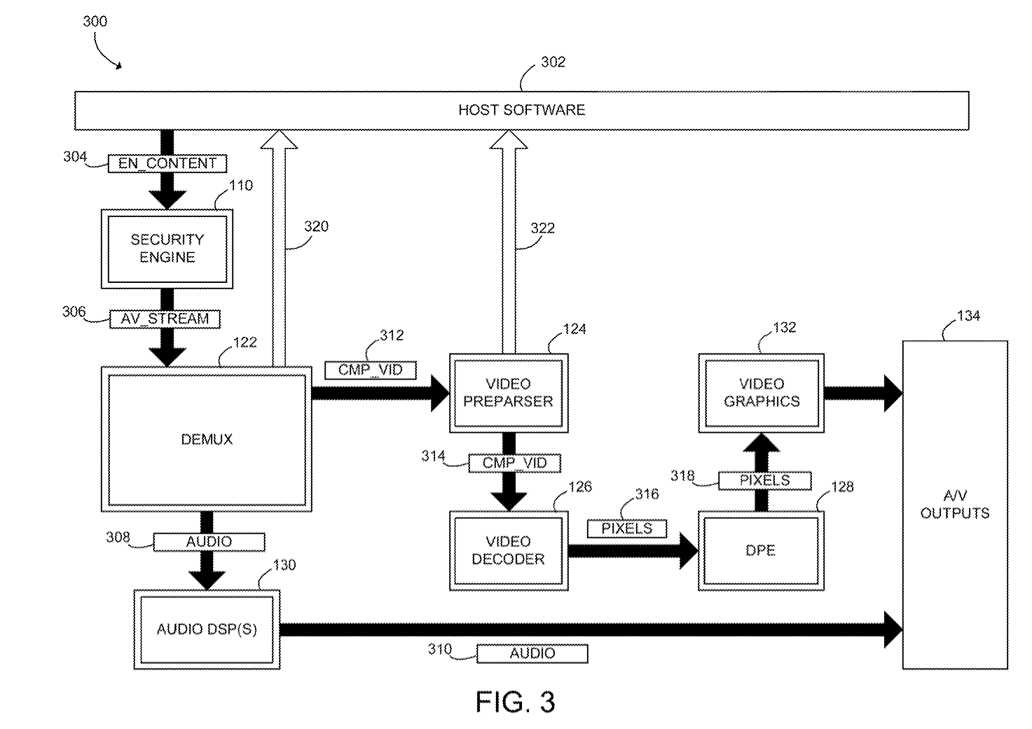

As discussed above, the establishment of the hardware enforced protected memory regions 200 and authentication of hardware peripherals 120 configures a trusted data path within the SOC 102 in which media content is protected throughout its delivery. For example, on illustrative embodied of a trusted data path 300 is shown in FIG. 3. In the diagram of FIG. 3, the trusted data path 300 is shown as filled arrows while unfilled arrows indicate an unprotected data path. Additionally, each authenticated hardware component of the SOC 102 is shown with double brackets to indicate that the component has been previously authenticated by the security engine 110.

As shown in FIG. 3, a host software 302 may be executed on the multimedia platform 100. The host software 302 may request delivery (e.g., playback) of encrypted media content 304. The encrypted media content 304 may be stored, for example, in the unprotected memory 104. In response to the delivery request, the security engine 110 retrieves the encrypted media content 304 from memory 160. The security engine 110 decrypts the media content into an A/V stream 306 using the encrypted application key 162. In so doing, as discussed in more detail below, the security engine 110 ensures that the application key 162 is never unprotected when in the decrypted state (e.g., the security engine 110 stores the decrypted application key in the secure memory 154). Similarly, the security engine 110 ensures the protection of the decrypted media content by storing the decrypted media stream in the protected memory region 200, which is accessible only by authenticated hardware peripherals 120.

The A/V stream 306 is accessed by the demux 122, which separates the audio and video from the A/V stream 306. Additionally, the demux 122 may provide section data 320 of the media content to the host software. The transfer of the section data 320 is unprotected as indicated by the unfilled arrow in FIG. 3. The audio 308 of the A/V stream 306 is accessed by the audio DSP 130, which generates a processed audio 310 to the A/V outputs 134. Additionally, the compressed video 318, of the AN stream 306 is accessed by the video preparser 124. The video preparser 124 may generate metadata 322, which is provided to the host software 302 in an unprotected transfer. The preparsed compressed video 314 is accessed by the video decoder 136, which generates video pixels 316. The video pixels 316 are accessed by the DPE 128 to generate video pixels 318, which are subsequently accessed by the video graphics 132 to generate the uncompressed video stream at the A/V outputs 134. In this way, the decryption and decompression of media content is performed in the SOC 102 through the trusted data path 300 such that access to the media content is protected throughout the delivery of the media content.

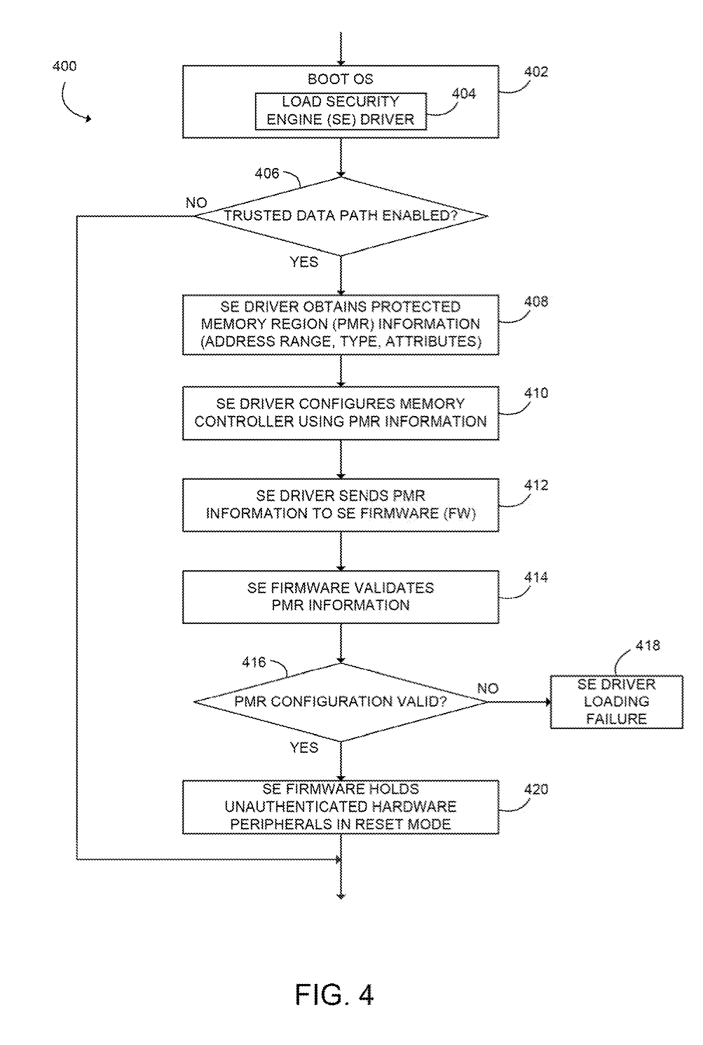

Referring now to FIG. 4, in use, the SOC 102 may execute a method 400 to establish the protected memory region 200. The method 400 begins with block 402 in which an operating system of the multimedia platform 100 may be loaded. During the boot process, the driver of the security engine 110 is loaded in block 404. In block 406, the SOC 102 determines whether the SOC 102 is configured for delivery of media content using the trusted data path. If not, the method 400 exits and the multimedia platform 100 boots as normal. However, if the SOC 102 is configured for trusted data path delivery, the method 400 advances to block 408 in which the security engine driver obtains information pertaining to the hardware enforced protected memory region 200. Such information may include, for example, the address range of each protected memory region 200, the region type of each protected memory region 200, and any additional attributes associated with each protected memory region 200. Such information may be obtained from a secured data table or the like. In block 410, the security engine driver sends the protected memory region information to the security engine firmware 152 for validation. The security engine firmware 152 validates the protected memory region information in block 414. The security engine firmware 152 may perform any type of validation on the protected memory regions including, for example, ensuring that the address ranges of the individual protected memory ranges of the protected memory region 200 do not overlap with each other, that the type and attributes correspond correctly, and so forth.

In block 416, the SOC 102 determines whether the configuration of the protected memory region 200 was determined to be valid by the security engine 110. If the configuration of the protected memory region 200 is not valid, the method 400 advances to block 418 in which a security engine driver error is generated in response thereto, the SOC 102 may perform one or more security actions including, for example, rebooting, reconfiguring the memory controller 114, and/or other corrective action. However, if the configuration of the protected memory region 200 is determined to he valid, the method 400 advances to block 420 in which the security engine firmware 152 holds all hardware peripherals 120, which have not yet been authenticated, in a reset mode.

After the memory controller 114 has been configured for the protected memory region 200, the security engine 110 of the SOC 102 may authenticate hardware peripherals 120 of the SOC 102. To do so, the SOC 102 may execute a method 500 for authenticating a hardware peripheral 120. The method 500 begins with block 502 in which the security engine 110 determines whether a request to load the firmware 140 of the hardware peripheral 120 has been received. If so, the security engine driver retrieves the cryptographic key 142 of the requesting hardware peripheral 120 and the associated encrypted firmware 140 in block 504. The security engine driver generates a firmware loading package including the peripheral cryptographic key 142, the encrypted peripheral firmware 140, and the memory address of the associated firmware protected memory region 202.

The security engine driver sends the firmware loading package to the security engine firmware 152 in block 508. In response, the security engine firmware 152 authenticates the peripheral cryptographic key 142 in block 510. To do so, the security engine firmware 152 may use the security key 150 of the security engine 110 to verify that the peripheral cryptographic key 142 was previously signed by the security engine 110.

In block 512, the SOC 102 determines whether the security engine 110 successfully authenticated the peripheral cryptographic key 142, if not, the method 500 advances to block 514 in which a peripheral driver loading error is generated, and the hardware peripheral is held in reset mode. Additionally, the SOC 102 may take additional security responses to such loading error.

If the peripheral cryptographic key 142 is authenticated by the security engine 110, the method 500 advances to block 516 in which the security engine firmware 152 authenticates the peripheral firmware 140 using the now-authenticated peripheral cryptographic key 142. For example, in embodiments wherein the firmware 140 is encrypted, the security engine 110 may decrypt the firmware 140. Additionally or alternatively, the security engine 110 may ensure that the firmware 140 has been previously signed using the peripheral cryptographic key 142 based on, for example, a hash function of the firmware 140 or the like.

In block 518, the SOC 102 determines whether the security engine 110 successfully authenticated the peripheral firmware 140. If not, the method 500 advances to block 514 in which a peripheral driver loading error is generated, and the hardware peripheral is held in reset mode. However, if the peripheral firmware 140 is authenticated, the method 500 advances to block 520 in which the security engine firmware 152 loads the authenticated (and decrypted) hardware peripheral firmware 140 into the associated firmware protected memory region 202 and releases the hardware peripheral 120 from reset mode. In this way, only authenticated firmware of the hardware peripherals is loaded and executed by the SOC 102. Additionally, only the authenticated hardware peripherals have access to the protected memory region 200 and the decrypted media content contained therein.

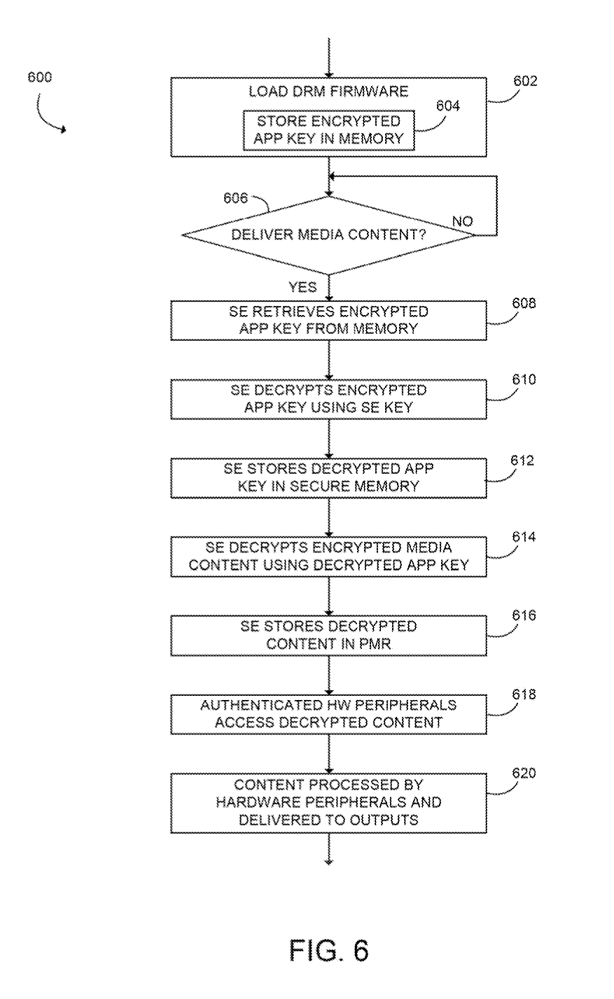

Referring now to FIG. 6, after the hardware peripherals 120 have been authenticated, the SOC 102 may deliver content to a user of the multimedia platform 100. To do so, the SOC 102 may execute a method 600 for delivering content media in a trusted data path. The method 600 begins with block 602 in which any digital rights management (DRM) firmware is loaded by the SOC. The DRM firmware may support the decryption operation of media content to be delivered on the multimedia platform 602. During the loading of the DRM firmware, an application cryptographic key 162 for decrypting the media content is stored in the memory 104. In the illustrative embodiment, the application cryptographic key 162 is stored in encrypted form in the unprotected memory 160 of the memory 104. Additionally, the encrypted media content to be delivered to the user may be stored in the unprotected memory 160.

In block 606, the SOC 102 determines whether a user has requested delivery of the media content. If so, the method 600 advances to block 608 in which the security engine 110 retrieves the encrypted application key 162 from the unprotected memory 160 of the memory 104. In block 610, the security engine 110 decrypts the application key 162 and stores the decrypted application key in the secure memory 154 of the security engine 110 in block 612. Subsequently, in block 614, the security engine 110 decrypts the encrypted media content, which may be stored in the unprotected memory 160, using the decrypted application key 162. The decrypted media content is stored in the streaming frame buffer protected memory region 204.

In block 618, authenticated hardware peripherals 120 access the decrypted media content in the protected memory region 200, and the media content is processed by the various authenticated hardware peripherals 120 and delivered to the A/V outputs 134 of the SOC 102 for playback to the user of the multimedia platform 100, in so doing, it should be appreciated that the decrypted application key 162 and the decrypted media content are never left in an unprotected state.

It should be appreciated that the above-described system delivers media content in a secure and protected manner. For example, the decrypted media content and the decrypted application key 162 are stored in protected and secured memory locations whenever in the decrypted state. Additionally, only authenticated hardware peripherals 120 have access to the protected memory region 200 in which the decrypted media content is stored during processing of the content for delivery. In this way, media content is secured within the SOC 102 itself during the delivery process.

While the disclosure has been illustrated and described in detail in the drawings and foregoing description, such an illustration and description is to be considered as exemplary and not restrictive in character, it being understood that only illustrative embodiments have been shown and described and that all changes and modifications consistent with the disclosure and recited claims are desired to be protected.

1-40. (canceled)

41. A system-on-a-chip apparatus comprising:
a memory having at least one protected region to store at least decrypted media content therein; and
a system-on-a-chip comprising:
a memory controller coupled to the memory to enforce protection of the protected memory region such that access to the protected memory region is permitted only to authenticated peripheral devices of the system-on-a-chip; and
a security engine coupled to the memory controller to authenticate a firmware of a hardware peripheral of the system-on-a-chip to allow the hardware peripheral access to the protected memory region of the memory.

42. The system-on-a-chip apparatus of claim 41, wherein the security engine to store the firmware of the hardware peripheral in the protected memory region in response to the firmware being authenticated by the security engine and allow execution of the firmware from the protected memory region to activate the hardware peripheral.

43. The system-on-a-chip apparatus of claim 41, wherein the firmware comprises an encrypted firmware of the hardware peripheral; and wherein the security engine to:
obtain a peripheral cryptographic key of the hardware peripheral and authenticate the peripheral cryptographic key using a security cryptographic key of the security engine;
authenticate the encrypted firmware using the peripheral cryptographic key in response to the peripheral cryptographic key being authenticated with the security cryptographic key; and
decrypt the encrypted firmware with the peripheral cryptographic key.

44. The system-on-a-chip apparatus of claim 41, wherein the security engine to retrieve an encrypted application key from memory in response to receiving a request to deliver media content.

45. The system-on-a-chip apparatus of claim 44, wherein the security engine to decrypt the encrypted application key with a security cryptographic key of the security engine and store the decrypted application key in the protected memory region.

46. The system-on-a-chip apparatus of claim 45, wherein the security engine to access encrypted media content and decrypt the media content using the decrypted application key.

47. The system-on-a-chip apparatus of claim 46, wherein the security engine to store the decrypted media content in the protected memory region.

48. The system-on-a-chip apparatus of claim 47, wherein the authenticated hardware peripheral to access the protected memory region to retrieve the decrypted media content.

49. The system-on-a-chip apparatus of claim 47, further comprising a plurality of authenticated hardware peripherals to deliver the decrypted media to an output of the system-on-a-chip such that no unauthenticated hardware peripheral access the decrypted media content.

50. One or more machine-readable storage media comprising a plurality of instructions stored thereon that, in response to execution by a computing device, causes the computing device to:
configure a memory controller of a system-on-a-chip to establish a protected memory region, the protected memory region accessible only by authenticated hardware peripherals;
authenticate a firmware of a hardware peripheral of the system-on-a-chip with a security engine of the system-on-a-chip;
store the firmware in the protected memory region in response to the firmware being authenticated by the security engine; and
execute the firmware from the protected memory region to activate the hardware peripheral.

51. The one or more machine-readable storage media of claim 50, wherein to configure the memory controller comprises to obtain protected memory region information and to configure the memory controller using the identified information.

52. The one or more machine-readable storage media of claim 51, wherein to obtain protected memory region information comprises to obtain an address range of the protected memory region.

53. The one or more machine-readable storage media of claim 51, wherein to obtain protected memory region information comprises to obtain an address range of the protected memory region, a type of the protected memory region, and at least one attribute of the protected memory region.

54. The one or more machine-readable storage media of claim 51, wherein the plurality of instructions further cause the computing device to validate the protected memory region information using the security engine of the system-on-a-chip.

55. The one or more machine-readable storage media of claim 50, wherein to authenticate the firmware of the hardware peripheral comprises to:
obtain a peripheral cryptographic key of the hardware peripheral and an encrypted firmware of the hardware peripheral,
authenticate the peripheral cryptographic key using a security cryptographic key of the security engine;
authenticate the encrypted firmware using the peripheral cryptographic key in response to the peripheral cryptographic key being authenticated using the security cryptographic key; and
wherein to authenticate the encrypted firmware comprises to decrypt the encrypted firmware using the peripheral cryptographic key.

56. The one or more machine-readable storage media of claim 50, wherein the plurality of instructions further cause the computing device to retrieve an encrypted application key from memory using the security engine in response to receipt of a request to deliver media content.

57. The one or more machine-readable storage media of claim 56, wherein the plurality of instructions further cause the computing device to decrypt the encrypted application key with a security cryptographic key of the security engine and to store the decrypted application key in the protected memory region.

58. The one or more machine-readable storage media of claim 57, wherein the plurality of instructions further cause the computing device to access encrypted media content and to decrypt the media content using the decrypted application key.

59. The one or more machine-readable storage media of claim 58, wherein the plurality of instructions further cause the computing device to store the decrypted media content in the protected memory region.

60. The one or more machine-readable storage media of claim 59, wherein the plurality of instructions further cause the computing device to access the protected memory region with an authenticated hardware peripheral to retrieve the decrypted media content.

61. The one or more machine-readable storage media of claim 59, wherein the plurality of instructions further cause the computing device to deliver the decrypted media to an output of the system-on-a-chip such that no unauthenticated hardware peripheral accesses the decrypted media content.

62. One or more machine-readable storage media comprising a plurality of instructions stored thereon that, in response to execution by a computing device, causes the computing device to:
configure a memory controller of a system-on-a-chip to establish a protected memory region;
receive, with a security engine of the system-on-a-chip, a peripheral cryptographic key of a hardware peripheral and an encrypted firmware of the hardware peripheral;
authenticate the peripheral cryptographic key using a security cryptographic key of the security engine;
authenticate the encrypted firmware using the peripheral cryptographic key in response to the peripheral cryptographic key being authenticated;
store the decrypted firmware in the protected memory region; and
execute the decrypted firmware from the protected memory region to release the hardware peripheral from a reset state.

63. The one or more machine-readable storage media of claim 62, wherein the plurality of instructions further cause the computing device to:
retrieve an encrypted application key from memory with the security engine in response to receipt of a request to deliver media content;
decrypt the encrypted application key with the security cryptographic key of the security engine and store the decrypted application key in the protected memory region; and
access encrypted media content and decrypt the media content with the decrypted application key.

64. The one or more machine-readable storage media of claim 63, wherein the plurality of instructions further cause the computing device to access the protected memory region with an authenticated hardware peripheral to retrieve the decrypted media content.

65. The one or more machine-readable storage media of claim 63, wherein the plurality of instructions further cause the computing device to deliver the decrypted media to an output of the system-on-a-chip such that no unauthenticated hardware peripheral accesses the decrypted media content.
